(19) United States
(12) Patent Application Publication
(10) Pub. No.: US 2022/0219983 A1
(43) Pub. Date: Jul. 14, 2022

(54) A PROCESS FOR INCREASING THE CONCENTRATION OF SULFURIC ACID AND EQUIPMENT FOR USE IN THE PROCESS

(71) Applicant: HALDOR TOPSØE A/S, Kgs. Lyngby (DK)

(72) Inventors: Martin MØLLERHØJ, Birkerød (DK); Morten THELLEFSEN, Hillerød (DK)

(73) Assignee: HALDOR TOPSØE A/S, Kgs. Lyngby (DK)

(21) Appl. No.: 17/613,112

(22) PCT Filed: Jul. 10, 2020
(86) PCT No.: PCT/EP2020/069595

§ 371 Date: Nov. 22, 2021

(30) Foreign Application Priority Data
Jul. 12, 2019 (DK) PA 2019 00867

(51) Int. Cl. C01B 17/88; B01D 5/00; B01D 3/00; B01D 1/14; B01D 1/12

(52) U.S. Cl. CPC C01B 17/88; B01D 5/009; B01D 1/12; B01D 3/009; B01D 1/14; B01D 5/0063

(57) ABSTRACT

A sulfuric acid recirculation loop and a standalone sulfuric acid concentrator including: a concentrator column, an air lift pump having a liquid inlet fed with concentrated sulfuric acid from the outlet of a sulfuric acid reservoir downstream the concentrator column, a gas inlet fed with a carrier fluid having a lower density than the concentrated sulfuric acid, and an outlet, wherein the sulfuric acid reservoir is located below the concentrator column and above the carrier fluid inlet of the air lift pump, a downcomer pipe leading down from the sulfuric acid reservoir to the liquid inlet of the air lift pump, and a riser pipe leading up from the carrier fluid inlet on the air lift pump to an inlet pipe for the concentrator column, the inlet pipe being configured for allowing a liquid flow from the inlet to the outlet.

The present invention relates to a process for increasing the concentration of already concentrated sulfuric acid and equipment for use in the process. This increase in concentration is useful in connection with the purification of sulfur-containing flue gases and off-gases, where sulfur is present as sulfur trioxide and is removed as sulfuric acid, which is formed by condensation of the sulfur trioxide/water containing gas. This process is called the wet gas sulfuric acid (WSA) process.

Sulfuric acid (H₂SO₄) is an important commodity chemical, the production of which exceeds 200 million t/year. It is primarily used for fertilizer production, but it is also used i.a. in the manufacture of pigments, in batteries, in the metallurgical industry and in refining industry.

Many applications of sulfuric acid require an acid concentration of at least 93 wt % H₂SO₄, where the remaining 7 wt % is water.

With regard to storage, transportation and sales value, a concentration of 98 wt % is desired or even required by the buyer and/or the freight company. This means that the demand for production of sulfuric acid with a higher acid concentration in sulfuric acid plants has increased.

In so-called wet gas sulfuric acid plants, where the process gas also contains water, it is often difficult to obtain a product acid concentration of 98 wt %. This is due to the strong hygroscopic properties of sulfuric acid and the presence of an azeotrope at around 98.6 wt % H₂SO₄.

In an attempt to increase the sulfuric acid concentration, so-called stand-alone sulfuric acid concentration plants have been developed.

In many of the processes for increasing the sulfuric acid concentration, cold dilute sulfuric acid is fed to the plant, where it is indirectly heated to a temperature very close to the boiling point of the sulfuric acid. A distillation process is taking place, i.e. the system is only H₂SO₄ and H₂O. To reach an acid concentration of above 98.0 wt %, more than one distillation step is required, and at least the last distillation step is operated under vacuum in order to lower the boiling temperature of the sulfuric acid. The so-called Plinke process is an example of the most widely used stand-alone sulfuric acid concentrating technology.

Some directly fired H₂SO₄ concentration units exist, in which dilute sulfuric acid is contacted with hot (˜600° C.) process gas from combustion of some sort of fuel. These units have the disadvantage of producing large volumes of process gas with a high concentration of sulfuric acid vapor, and the sulfuric acid product concentration rarely exceeds 93 wt %. The Submerged Combustion process and the Chemico Direct Fired Drum concentrator are examples of this technology.

Another solution, which can be used to increase the concentration of the sulfuric acid product from a wet gas sulfuric acid plant, is to include a so-called Integrated Sulfuric acid Concentrator (ISAC) in the design of the sulfuric acid plant. The ISAC can be mounted at the liquid outlet of the sulfuric acid condenser, in which sulfuric acid condenses from the gas phase by direct or indirect cooling of the process gas containing sulfuric acid and water vapor.

“Integrated” means that the liquid inlet of the ISAC is in direct fluid communication with the liquid outlet of the sulfuric acid condenser, and the hot air leaving the ISAC column is in contact with the gas inlet to the sulfuric acid condenser.

In the ISAC, the hot already concentrated sulfuric acid from the sulfuric acid condenser is contacted with hot dried air in a concentrator column, flowing in counter-current to the sulfuric acid, thereby forcing water and a little sulfuric acid to evaporate from the sulfuric acid, thus increasing the sulfuric acid concentration at the outlet of the ISAC. The dried air leaves at the top of the ISAC and enters at the bottom of the sulfuric acid condenser, where the sulfuric acid vapors are condensed, while the sulfuric acid is returned to the top of the ISAC. This process is described in further detail in EP 0 844 211 and US 2011/0311433.

However, although elegant, the ISAC unit cannot always increase the sulfuric acid concentration to the desired level of 98 wt %. According to US 2011/0311433, if the concentration of the sulfuric acid entering the top of the ISAC is 93.0 wt %, the concentration at the outlet will be ˜96.3 wt %. The sulfuric acid concentration capacity is limited by the requirement that the concentrator must be wetted, which limits the allowable flow of hot dried air as a function of the flow of the sulfuric acid entering the ISAC.

To further concentrate the sulfuric acid, a sulfuric acid recirculation loop was invented and described in WO 2018/108739 A1. By recirculating and optionally further heating the hot concentrated sulfuric acid from the concentrator column to a position upstream the concentrator column, it becomes possible to obtain >98.0 wt % H₂SO₄ almost independent of the sulfuric acid concentration from the sulfuric acid condenser.

The present invention is an improvement of the recirculation sulfuric acid concentration technology described above, in which the centrifugal sulfuric acid circulation pump has been replaced with an air lift pump, reducing cost of the system and increasing reliability and possibility for repair and maintenance of the sulfuric acid circulation system.

In the present context where concentrations are stated in vol % this shall be understood as volumetric % (i.e. molar percentages for gases).

In the present context, nominal concentration means that the concentrations of SO₃ and H₂O are calculated on the assumption of no hydration of SO₃.

In the present context the term stripping medium shall be used for a gas directed through concentrated sulfuric acid with the purpose of concentrating the sulfuric acid by driving water out of the acid. The stripping medium may be any available gas compatible with the sulfuric acid, typically ambient or dried air or process gas with a high amount of air.

In the present context where concentrations are stated in wt % this shall be understood as weight/weight %.

A broad aspect of the present disclosure relates to a sulfuric acid recirculation loop comprising:
an optional sulfuric acid condenser column,
a concentrator column,
an air lift pump having a liquid inlet fed with hot concentrated sulfuric acid from the outlet of a sulfuric acid reservoir downstream the concentrator column, a gas inlet fed with a carrier fluid having a lower density than the hot concentrated sulfuric acid, and an outlet,
wherein the sulfuric acid reservoir is located below the concentrator column and above the carrier fluid inlet of the air lift pump,
a downcomer pipe leading down from the sulfuric acid reservoir to the liquid inlet of the air lift pump, and
an riser pipe leading up from the carrier fluid inlet on the air lift pump to an inlet pipe for the concentrator column, said inlet pipe having an inlet and an outlet and an increased diameter compared to the riser pipe, and said inlet pipe being configured for allowing a liquid flow from the inlet to the outlet and configured for at least partially separating recirculated sulfuric acid and carrier fluid, and directing both fluids to the inlet of the concentrator column. This has the benefit of providing acid with elevated concentration in a system without moving parts being in contact with the sulfuric acid.

In a further embodiment the sulfuric acid product is withdrawn through an overflow pipe in the sulfuric acid reservoir. This has the benefit of a process which is easy to control.

In a further embodiment the sulfuric acid recirculation loop comprises a sulfuric acid heater positioned between the outlet of the air lift pump and the inlet to the sulfuric acid concentrator column, and where the sulfuric acid and optionally the carrier fluid from the outlet of the air lift pump is heated to a temperature of 200-270° C. This has the benefit of the water vapor pressure being higher at elevated temperatures, and especially higher than that of the sulfuric acid vapor pressure in this temperature range, such that water is removed.

In a further embodiment the carrier fluid is air that is optionally heated in carrier fluid heater positioned upstream the air lift pump. This has the benefit of air being conveniently available as well as a potential for a higher lifting power due to the lower density of the heated air, as well as a reduced risk for formation of acid mist aerosols.

In a further embodiment the sulfuric acid recirculation loop comprises two or more air lift pumps arranged in parallel. This has the benefit of a higher lift capacity, which is especially relevant when the variation in flow is high or the flow of recycle in the concentrator is high, since parallel systems may have a lower tube diameter, and thus simpler flange design.

In a further embodiment the inlet pipe is split into a dedicated pipe for sulfuric acid and a dedicated pipe for carrier fluid, the two pipes directing their fluids to positions above the inlet of the concentrator column and/or at the bottom of sulfuric acid condenser. This has the benefit of obtaining a more calm flow of acid, and thus less acid mist formation.

In a further embodiment the separation of sulfuric acid and carrier fluid, coming from the riser pipe, is carried out in a separator vessel or a separator pipe with an inner diameter larger than the inner diameter of the riser pipe, preferably minimum 2 times the inner diameter of the riser pipe and two connecting outlets connecting a dedicated pipe for sulfuric acid and a dedicated pipe for carrier fluid, the two pipes directing their fluids to positions above the inlet of the concentrator column and/or at the bottom of sulfuric acid condenser. This has the benefit of obtaining improved separation between carrier fluid and sulfuric acid.

In a further embodiment a stream of sulfuric acid, colder than the recirculated sulfuric acid, is mixed with the recirculated sulfuric acid in a position upstream the inlet to the air lift pump. This has the benefit of reducing the temperature and thus protecting the piping system against corrosion and leakages due to thermal creeping of the fluoropolymer lining in the flange connections.

A further aspect of the present disclosure relates to a stand-alone sulfuric acid concentrator system comprising
a concentrator column having an inlet and an outlet,
an optional sulfuric acid condenser column,
a first air lift pump having a liquid inlet fed with hot concentrated sulfuric acid from the outlet of a concentrator column, a gas inlet fed with a first carrier fluid, having a lower density than the hot concentrated sulfuric acid, and an outlet,
a separating unit, such as an overflow vessel, in which the stream from first air lift pump is split into a hot sulfuric acid product stream directed to the sulfuric acid product cooler, a sulfuric acid stream for recirculation and said first carrier fluid being directed to the inlet of the concentrator column or to the bottom of the sulfuric acid condenser,
a sulfuric acid product cooler, for pre-heating a cold sulfuric acid feed stream by heat exchange with a hot concentrated sulfuric acid product stream,
a second air lift pump, having a liquid inlet fed with the sulfuric acid stream for recirculation and the preheated sulfuric acid feed and a gas inlet fed with a second carrier fluid, having a lower density than the sulfuric acid stream for recirculation, and an outlet,
an inlet pipe, said inlet pipe having an inlet and an outlet and an increased diameter compared to the riser pipe, said inlet pipe being configured for allowing a liquid flow from the inlet to the outlet and configured for at least partially separating sulfuric acid and second carrier fluid, and directing both fluids to the inlet of the concentrator column or to the bottom of the sulfuric acid condenser,
a sulfuric acid reservoir located upstream of and above the first air lift pump, either integrated in the concentrator column or as a separate tank or vessel. This has the benefit of enabling a higher sulfuric acid concentration from an existing sulfuric acid production plant in a system without moving parts being in contact with the sulfuric acid.

In a further embodiment the stand-alone sulfuric acid concentrator comprises a sulfuric acid heater, positioned such that the stream from the second air lift pump is heated to 200-270° C. before being fed to the inlet of the concentrator column or the bottom of the sulfuric acid condenser. This has the benefit of the water vapor pressure being higher at elevated temperatures, and especially higher than that sulfuric acid vapor pressure in this temperature range, such that water is removed.

In a further embodiment which the carrier fluid is air and is optionally heated in a carrier fluid heater upstream the first and second air lift pump. This has the benefit of air being conveniently available as well as a potential for a higher lifting power due to the lower density of the heated air, as well as a reduced risk for formation of acid mist aerosols.

In a further embodiment the stand-alone sulfuric acid concentrator comprises two or more air lift pumps which are arranged in parallel. This has the benefit of a higher lift capacity, which is especially relevant when the variation in flow is high or the flow of recycle in the concentrator is high, since parallel systems may have a lower tube diameter, and thus simpler flange design.

In a further embodiment the inlet pipe comprises a dedicated pipe for sulfuric acid and a dedicated pipe for carrier fluid, the two pipes directing their fluids to positions above the inlet of the concentrator column and/or at the bottom of sulfuric acid condenser. This has the benefit of obtaining a more calm flow of acid, and thus less acid mist formation.

In a further embodiment the separation of sulfuric acid and carrier fluid coming from the riser pipe is carried out in a separator vessel or a separator pipe with an inner diameter larger than the inner diameter of the riser pipe, preferably minimum 2 times the inner diameter of the riser pipe and two connecting outlets connecting a dedicated pipe for sulfuric acid and a dedicated pipe for carrier fluid, the two pipes directing their fluids to positions above the inlet of the concentrator column and/or at the bottom of the sulfuric acid condenser. This has the benefit obtaining improved separation between carrier fluid and sulfuric acid.

In a further embodiment a stream of sulfuric acid, colder than the recirculated sulfuric acid, is mixed with cooled recirculated sulfuric acid in a position upstream the inlet to the air lift pump. This has the benefit of reducing the temperature and thus protecting the piping system against corrosion.

The present invention relates to a process for increasing the concentration of already concentrated, i.e. 90-98 wt % sulfuric acid, said process comprising the step of stripping water from the sulfuric acid by contacting it with a stripping medium selected from air and process gas in a sulfuric acid concentrator column to increase the concentration of the sulfuric acid leaving the column, wherein a fraction of the sulfuric acid, which is leaving the column, is recycled back to a position upstream the column through a sulfuric acid recirculation loop by means of an air lift pump.

The stripping medium used for stripping can be a process gas, ambient air or dried air. Preferably, the air used for stripping has a water concentration below 4 vol %, most preferably below 0.8 vol %. When process gas is used as stripping medium, it preferably has a concentration of H₂O (nominal) minus the concentration of SO₃ (nominal) below 4.5 vol %, most preferably below 1 vol %.

The stripping medium may have a temperature of 100-700° C., preferably 300-700° C. and most preferably 350-600° C.

The sulfuric acid is optionally heated during its passage through the sulfuric acid recirculation loop. It is preferred that the sulfuric acid is heated to a temperature of 200-270° C., preferably 230-260° C., during its passage through the sulfuric acid recirculation loop.

Preferably the already concentrated sulfuric acid is a sulfuric acid condenser effluent with a concentration of 70-98 wt %, preferably 90-98 wt %.

The product acid concentration will be in the range between the inlet concentration and ˜98.6 wt %, which represents the azeotrope concentration, i.e. the maximum obtainable concentration. With the present invention, adjustment of the sulfuric acid recycle ratio, sulfuric acid temperature, flow and temperature of the stripping medium allows for a flexible and robust operation of the unit, allowing to produce 98.0 wt % sulfuric acid, independent of the acid concentration from the sulfuric acid condenser.

The stripping medium can be heated by electrical heating or by indirect heat exchange with saturated or superheated steam, process gas, hot air, molten heat transfer salt or heat transfer oil. Any combination of the mentioned air heating methods is also applicable. Preferably the heated stripping medium has a temperature of 100-700° C. when it enters the concentrator column.

The present invention further relates to a sulfuric acid recirculation loop for carrying out the process for increasing the concentration of already concentrated sulfuric acid, comprising an air lift pump fed with hot concentrated sulfuric acid from the outlet of a sulfuric acid concentrator column, optionally a sulfuric acid heater, in which a fraction of the sulfuric acid from the outlet of the concentrator column is heated to a temperature of 200-270° C., and a pipe directing the heated sulfuric acid to a position upstream of the concentrator column.

In the prior art, the sulfuric acid circulation pump is a centrifugal pump in which the sulfuric acid is moved by a rotating propeller. Such pumps are the commonly used type for transporting practically all fluids as they are efficient, cheap and capable of providing a high discharge pressure (or lifting height).

In the present situation, pumping hot concentrated sulfuric acid, the materials of construction for the pump must be chosen from a very limited selection, such as PTFE (Teflon) and high Si steel types. These materials are at the limit of their resistance to the corrosive hot sulfuric acid and furthermore the high Si steel types are somewhat brittle and have an increased risk of breaking.

Furthermore, it is normal practice to install valves at the inlet and outlet of the pump, such that the pump can be isolated for e.g. service and maintenance. These valves suffer the same limitations with regard to materials of construction.

Furthermore, the most commonly used high silicon iron pumps used for hot sulfuric acid apply a hydrodynamic shaft seal. This means that the pump may leak minor amounts of sulfuric acid when the pump is not running.

In the present invention, these limitations are overcome by replacing the centrifugal sulfuric acid pump of prior art by one or more air lift pump(s). The air lift pump principle has been in use for almost 150 years, the use has primarily been recirculation of water in aquariums, moving waste water (e.g. with sludge) and in gas and oil extraction. In the air lift pump, liquid is put in motion by the difference in density between a pure liquid and a carrier fluid/liquid two-phase mixture.

The advantage of the air lift pump is the simplicity, the low cost, the resistance towards debris and particles in the fluid to be pumped and the possibility to make intimate contact between the carrier fluid (usually air) and the fluid. The latter is very useful for aerating aquarium water and waste water.

The disadvantage of the air lift pump is that it cannot overcome large pressure drops and/or elevate the fluid to high elevations. Besides, the air lift pump works most efficiently if there is a liquid reservoir in a relatively high elevation above the lower part of the air lift pump, which puts limitations into the applicability of the pump. However, for the present invention, the required lifting height is modest and the plant layout has elevation for providing a relatively high submerged liquid column.

The working principle of the air lift pump is putting the fluid into motion by means of difference in fluid density. This is typically accomplished by having an elevated reservoir for the liquid to be moved. From the reservoir a pipe connection goes down to a low point at which the pipe is bent into an upward vertical direction and in that upward going pipe, called the riser, an amount of air (or other gases) is injected into the liquid as a carrier fluid. The carrier fluid can be injected at any position on the riser pipe, but the efficiency is highest for air injection at or close to the low point because this provides the maximum ratio between the driving liquid column above the injection point (i.e. the difference in elevation between the reservoir surface and injection point) and the lifted two-phase fluid above the injection point. This ratio is called the submergence ratio. The carrier fluid (air) injection results in a density of the mixed fluid in the riser pipe becoming lower than the density in the downward pipe and the two-phase fluid will start moving upward in the riser pipe, if the driving pressure of the liquid column is above that of the lifted mixed fluid column.

The flow rate and lifting height of the upward flowing fluid depends on several parameters, where the submergence ratio and the amount of air (i.e. density difference between downward moving liquid from reservoir and upward flowing two-phase fluid in the riser pipe) and the diameter of the riser pipe are the most important. Pumping is thus obtained without moving parts being in contact with the pumped medium, which of course is beneficial when pumping a corrosive medium such as sulfuric acid.

Whereas the piping layout on the inlet side of the air lift pump can be more freely chosen with regard to length, bends and slope, the riser pipe should be close to vertical. The inlet piping layout has merely an impact on the pressure loss of the moving liquid, decreasing the liquid flow rate by introducing extra pressure drop. However, the riser pipe from the air lift pump is preferably close to vertical as e.g. a horizontal section will result in a separation between carrier fluid and liquid and thus the pump efficiency will become drastically reduced.

There are many ways of admitting the air into the riser pipe, such as a single air pipe or jet, a number of holes in the periphery of the riser pipe, a hole plate with a number of small holes etc. The air lift pump will work with any injection of carrier fluid, but the exact way of injecting the air may have practical benefits.

In the present invention, the pipes for transporting the sulfuric acid may be glass or fluoro-polymer lined steel and the air injection system may beneficially be made of the same material.

The flow of sulfuric acid can be controlled by adjusting the flow of carrier fluid to the riser pipe.

The carrier fluid used for the air lift pump can be ambient air that has been compressed, either in a dedicated compressor/blower or tapped from a compressed air system, which is typically available at any larger process plant. The carrier fluid does not have to be air, but can be any gas or gas mixture that has a lower density than the fluid to be transported. The pressure must only exceed the pressure of the acid at the carrier fluid inlet, typically by 1 bar, so the required pressure is moderate. The air can be dried to remove water vapor that otherwise can be absorbed into the sulfuric acid and thus lower the concentration and/or the carrier fluid could be heated prior to admittance. However, as the carrier fluid flow is quite small compared to the sulfuric acid flow (typically 6 Nm³ to 20 Nm³ air/ton sulfuric acid), the air will quickly equilibrate thermally with the sulfuric acid without making any significant changes in sulfuric acid concentration or temperature.

Steam can also be used as carried fluid. The advantage of using steam as carrier fluid is that low pressure steam may be readily available at the plant site. The disadvantage of using steam is that some of the steam will be absorbed in the circulated sulfuric acid and somewhat lowering the efficiency of the acid concentrator as more stripping air will be required. In practice a balance between the cost of additional stripping air, the value of the steam required and the avoided cost of compressed air for carrier fluid may be used to determine the preferred carrier fluid.

As the preferred layout of the sulfuric acid concentrator provides room for a submerged section and the lifting height is modest, the disadvantages of the air lift pump are not hampering the applicability of the air lift pump. To increase the submerged height, the concentrator elevation (sulfuric acid reservoir) could be increased or the low point elevation decreased, e.g. by providing an underground pit for the lower sections of the downcomer and riser pipes.

The air lift pump will elevate the sulfuric acid to a position above the concentrator column, such as the bottom of the sulfuric acid condenser of the WSA plant (if present) or just above the liquid distributor, which is placed directly above the sulfuric acid concentrator column, which typically is a packed bed. Prior to admitting the sulfuric acid into the concentrator, a horizontal or slightly downward inclined pipe piece is installed to ensure a good separation between carrier fluid and liquid, such that the sulfuric acid flows more calmly into the liquid distributor. The carrier fluid will contain sulfuric acid vapor and possibly a small amount of sulfuric acid mist and is preferentially also admitted into the concentrator, where it can move upward into the sulfuric acid condenser. By doing that, there will be no slip stream of carrier fluid containing sulfuric acid to the atmosphere.

For good separation between carrier fluid and liquid, the cross section area of the riser pipe must be large enough for the two-phase flow in the pipe to be stratified flow with two distinct phases which typically requires about a doubling of the pipe inner diameter compared to the riser pipe where the flow regime is a bubble flow, such as slug flow or churn flow during most operating conditions.

The segregated sulfuric acid and carrier fluid stream can be admitted through the same pipe or be split before the concentrator and admitted through two pipes.

In addition to the process for increasing the concentration of sulfuric acid, the invention also concerns various embodiments of equipment for use in the process, which are described in the following. Numbers in brackets refer to the drawings, in which

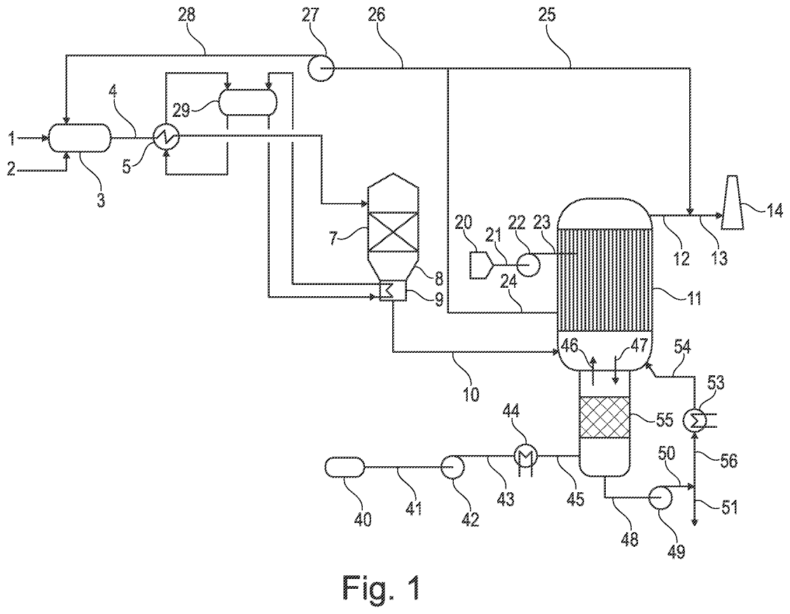

FIG. 1 shows a WSA plant equipped with a sulfuric acid concentration column with sulfuric acid recirculation by means of a centrifugal pump, presenting prior art.

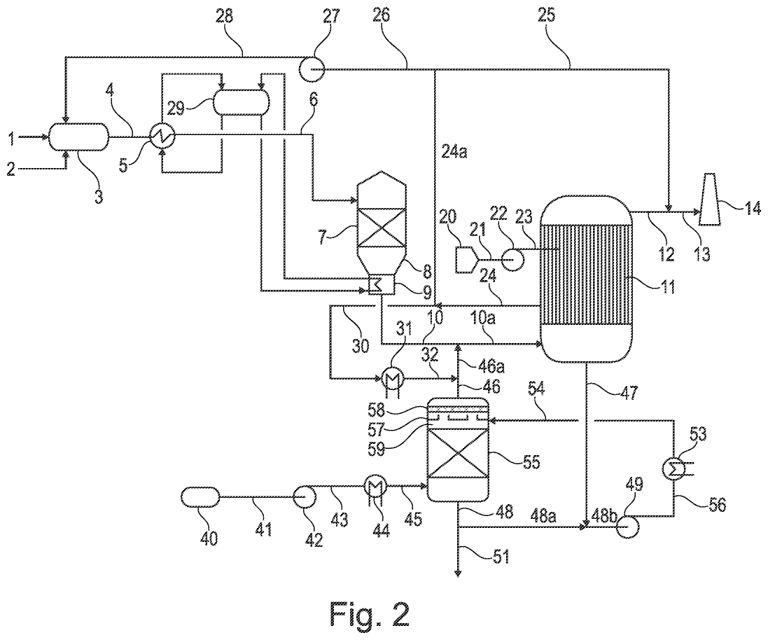

FIG. 2 shows another embodiment of a WSA plant of prior art, where the concentration column is installed in an external vessel to the sulfuric acid condenser,

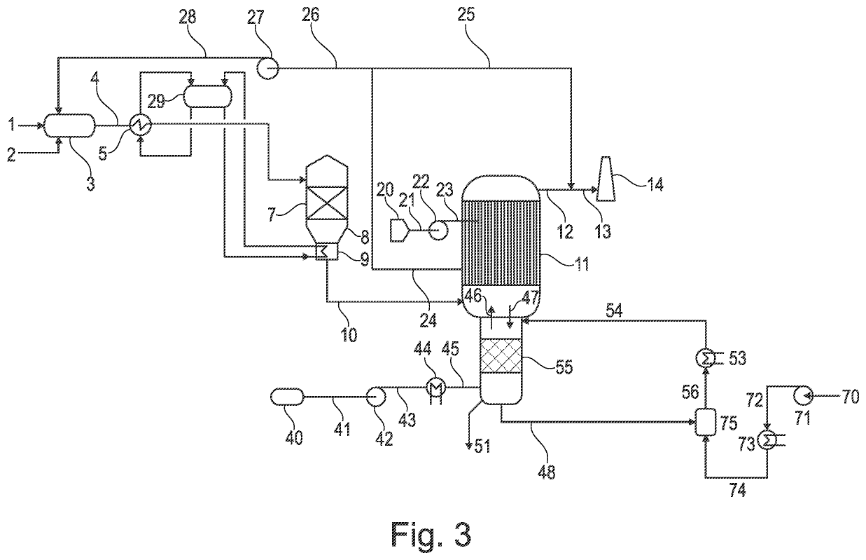

FIG. 3 shows a WSA plant equipped with a sulfuric acid concentration column with sulfuric acid recirculation by means of an air lift pump.

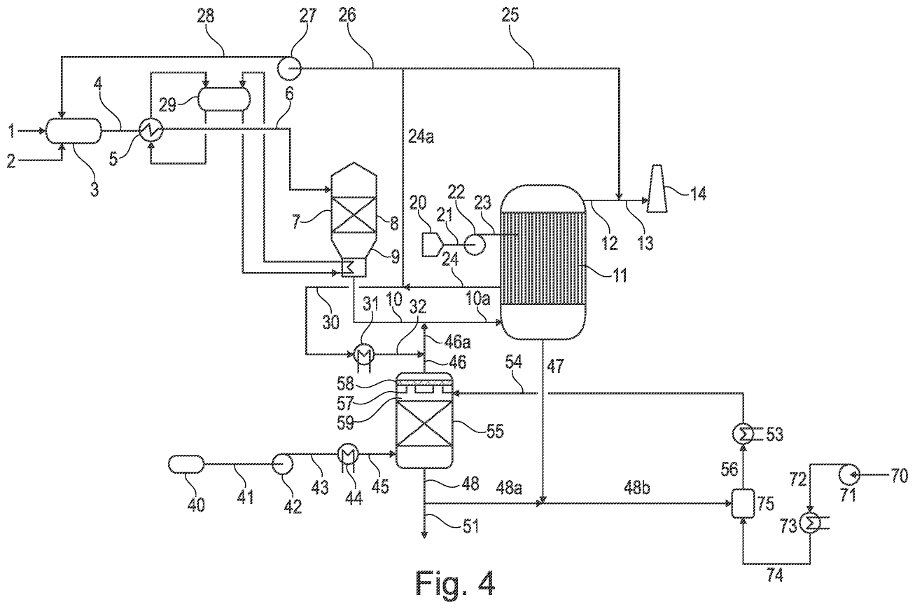

FIG. 4 shows another embodiment of a WSA plant, where the concentration column is installed in an external vessel to the sulfuric acid condenser with sulfuric acid recirculation by means of an air lift pump.

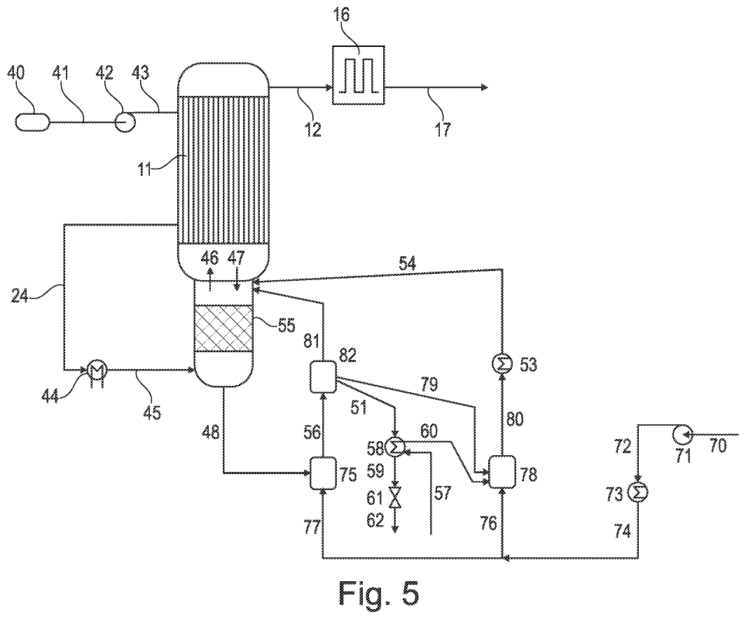

FIG. 5 shows an embodiment, where the concentration column is a stand-alone unit, receiving cold sulfuric acid from an unknown source and sulfuric acid is transported by one or more air lift pumps.

The various embodiments of equipment for use in the process according to the invention are described in more detail in the following.

Description of a WSA Plant Equipped with a Sulfuric Acid Concentration Column

A typical wet gas sulfuric acid (WSA) plant treating a feed stream, which contains one or more sulfur compounds, by converting the sulfur compounds into concentrated sulfuric acid according to prior art as described in WO 18108739A1, is shown in FIG. 1.

The sulfur-containing feed (1), which can be liquid as well as gaseous, is incinerated with hot air (28) and optionally a support fuel (2) in a thermal combustor (3) at 800-1200° C. At this temperature, all sulfur in the feed stream is converted into sulfur dioxide (SO₂). The SO₂-containing process gas (4) is then cooled in a waste heat boiler (5) prior to converting between 97 and 99.9% of the SO₂ to SO₃ in an adiabatic catalytic layer (7) containing a catalyst for converting SO₂ to SO₃. Depending on the required conversion efficiency of SO₂, one to three catalytic layers with process gas cooling in between will be necessary.

The fully converted process gas (8) is then cooled to 250-300° C. in the process gas cooler (9). In the process gas cooler, a fraction of the SO₃ reacts with water vapor to form sulfuric acid vapor (hydration of SO₃). Then the process gas (10) is further cooled to about 100° C. in the sulfuric acid condenser (11), where the final hydration of SO₃ and condensation of H₂SO₄ takes place.

The sulfuric acid condenser (11) can either be configured with process gas (10) flowing in vertical tubes and cooling air (23) flowing on the shell side, or alternatively with process gas (10) on the shell side of horizontal tubes and cooling air (23) or sulfuric acid plant feed gas on the tube side. The sulfuric acid condenser can also be configured as a packed column where the process gas is contacted in counter current with circulating sulfuric acid.

The cleaned process gas (12) is optionally reheated by addition of hot air (25), and then the optionally heated gas (13) is emitted to the atmosphere through the stack (14).

Alternatively, the cleaned process gas (12) is sent to a tail gas treatment unit, provided that the composition of pollutants in the cleaned gas exceeds the local emission limits. Such tail gas treatment units are typically scrubbers for SO₂ removal and/or filters for sulfuric acid mist removal. The tail gas treatment unit can also be a second SO₂ converter and a second sulfuric acid condenser.

The sulfuric acid (47) condensed in the sulfuric acid condenser flows into the top of the concentrator column (55). On the top of the column is a liquid distributor, ensuring that the sulfuric acid being fed to the packed bed of the concentrator column is evenly distributed over the entire cross sectional area, providing the best possible contact between sulfuric acid and dried air. In the packed bed of the concentrator column, just downstream of the liquid distributor, the sulfuric acid is contacted in counter-current with air, here hot dried air (45) produced in a dry air unit (40). The dry air unit is typically a desiccant absorption dehumidifier, but the dry air can also be ambient air compressed to 5-10 barg and/or cooled to low temperature in order to condense out the bulk part of the water.

The dried air is typically heated to 200-300° C. before being sent to the concentrator column.

By stripping off mainly water, but also some sulfuric acid, from the downward flowing sulfuric acid, the sulfuric acid concentration increases. The dried air containing the water and sulfuric acid vapors (46) flows into the bottom of the sulfuric acid condenser (11), where it is mixed with the process gas (10) coming from the process gas cooler (9).

The hot concentrated sulfuric acid leaving the bottom of the ISAC column (48) flows to the centrifugal hot sulfuric acid pump (49), where the pressure of the sulfuric acid is increased to compensate for any pressure drop(s) in optional downstream heat exchanger(s) and to increase elevation in the sulfuric acid circulation loop (56+54).

To ensure that the sulfuric acid pump does not run dry, a reservoir or tank is preferably located at the suction side of the pump. It can either be integrated in the sulfuric acid concentrator column or be a separate tank, located between the outlet of the concentrator column (55) and the inlet to the sulfuric acid recirculation pump (49).

The hot sulfuric acid (50) leaving the sulfuric acid pump is then split into two streams. The sulfuric acid product stream (51) is directed to the sulfuric acid cooling system (not shown) for cooling to 30-40° C. and sent to storage, transportation or use in another process.

The sulfuric acid circulation stream (56) is optionally directed to a sulfuric acid heater (53), where the sulfuric acid temperature is increased to 200-270° C. Then the hot sulfuric acid (54) is directed to the top of the concentrator column (55), where the hot sulfuric acid is mixed with the sulfuric acid from the sulfuric acid condenser (47) and flows downwards through the packed bed of the concentrator column (55).

Alternatively, the sulfuric acid product stream (51) can be withdrawn upstream the sulfuric acid pump (49) by means of an overflow pipe located in the sulfuric acid reservoir, either external or integrated into the concentrator column (55). One advantage of the sulfuric acid circulation loop is that the concentration of the sulfuric acid at the top of the concentrator column is increased (47), thereby further increasing the sulfuric acid concentration at the outlet (48) of the concentrator column.

Another advantage is that the increased flow of sulfuric acid in the concentrator column allows for a higher flow of dried hot air (45), not exceeding the maximum gas-to-liquid ratio which for this system is around 0.4 Nm³ air/kg sulfuric acid. Operating with higher gas-to-liquid ratios will increase the risk of drying out parts of the packed bed, resulting in lower stripping efficiency in the column.

These two advantages allow production of >98.0 wt % sulfuric acid product at almost any given concentration of sulfuric acid leaving the bottom of the sulfuric acid condenser (11).

As indicated above, the sulfuric acid circulation system can also be designed without the sulfuric acid heater (53), but then the temperature of the dried air (45) is preferably increased to 300-700° C. in order to supply sufficient energy to strip off water from the sulfuric acid. That is beneficially done in combination with recycling sulfuric acid to the top of the concentrator column such that complete wetting of the packing is ensured and heat is efficiently transferred from the hot dried air to the down flowing sulfuric acid. Insufficient cooling of the hot dried air can damage the sulfuric acid condenser.

In an alternative layout, the recycle sulfuric acid line (54) is directed to the bottom of the sulfuric acid condenser and is mixed with the condenser sulfuric acid before being directed to the top of the concentrator column, thereby providing a better mixing of the two sulfuric acid streams and a simpler mechanical construction.

Description of a WSA Plant Equipped with an External Sulfuric Acid Concentration Column

Another embodiment of the prior art is shown in FIG. 2. In this embodiment, the concentrator column (55) is installed in an external vessel to the sulfuric acid condenser (11) but the principles of sulfuric acid concentration are the same as described for FIG. 1. The sulfuric acid from the sulfuric acid condenser (47) flows directly to the centrifugal hot sulfuric acid pump (49) which is used to pump the sulfuric acid through an optional sulfuric acid heater (53) and up to the elevation of the liquid inlet of the concentrator column (54). This means that sulfuric acid outlet of the sulfuric acid condenser (11) does not have to be elevated above the concentrator column (55) to allow gravity flow of the sulfuric acid from the sulfuric acid condenser to the concentrator column. The H₂SO₄ and H₂O containing air from the sulfuric acid concentrator (46) is preferably transferred to the sulfuric acid condenser by mixing it with the process gas from the SO₂ converter (10). Any liquid entrainment or sulfuric acid mist in the air from the sulfuric acid concentrator column (59) is optionally removed in a demister (58) before the cleaned sulfuric acid concentrator off-gas (46) is added to the process gas from the SO₂ converter (10).

In order to prevent condensation of sulfuric acid in the process gas ducts (46a) and (10a), 300-700° C. hot air (32) is preferably added to the cleaned sulfuric acid concentrator off-gas air (46) before mixing with the process gas from the SO₂ converter (10). The combined process gas (10a) is then transferred to the sulfuric acid condenser (11). The source of hot air (32) is preferably hot cooling air (24) from the sulfuric acid condenser (11) which is further heated to a temperature of 300-700° C. in an additional air heater (31). Alternatively, the hot air (32) can be taken as a side stream from the hot dried air to the sulfuric acid concentrator (45).

The stripping medium does not have to be dried air, but could also be ambient air, provided that the water content is not too high. Similarly, any process gas with a sufficiently low water content can also be used as stripping air. In such a case, the air drying unit can be omitted, reducing both capital and operating cost.

Process gas is understood as process gas from the WSA plant or from any other process plant. The most important parameter of the process gas is the concentration of water in the process gas. In the case where the process gas is taken from the WSA plant, e.g. from the outlet of the last catalyst bed in the SO₂ converter (8), the water concentration is considered relative to the concentration of sulfur trioxide, because sulfur trioxide will react with water in the process gas to form sulfuric acid according to the hydration reaction (1):

SO₃ (g)+H₂O (g)=H₂SO₄ (g)+101 KJ/mole (1)

Similar to the use of ambient air as stripping medium, it can, however, be difficult to obtain sulfuric acid product concentrations of 98.0-98.5 wt % when the H₂O concentration on nominal basis subtracted the SO₃ concentration on nominal basis is higher than about 3-4.5 vol %.

The sulfuric acid product is withdrawn via line 51, in a position upstream the centrifugal sulfuric acid pump (49), preferably via an overflow pipe in the sulfuric acid reservoir in the concentrator column (55).

Description of a WSA Plant Equipped with an Integrated Sulfuric Acid Concentration Column and Sulfuric Acid Recirculation by Means of an Air Lift Pump

The WSA plant treating sulfur-containing feeds to form concentrated sulfuric acid, in which an integrated sulfuric acid concentration unit is provided with a sulfuric acid recirculation loop using an air lift pump, is shown in FIG. 3 and described in detail below.

The sulfur-containing feed (1), which can be liquid as well as gaseous, is incinerated with hot air (28) and optionally a support fuel (2) in a thermal combustor (3) at 800-1200° C. At this temperature, all sulfur in the feed stream is converted into sulfur dioxide (SO₂). The SO₂-containing process gas (4) is then cooled in a waste heat boiler (5) prior to converting between 97 and 99.9% of the SO₂ to SO₃ in an adiabatic catalytic layer (7) containing a catalyst for converting SO₂ to SO₃. Depending on the required conversion efficiency of SO₂, one to three catalytic layers with process gas cooling in between will be necessary.

The fully converted process gas (8) is then cooled to 250-300° C. in the process gas cooler (9). In the process gas cooler, a fraction of the SO₃ reacts with water vapor to form sulfuric acid vapor (hydration of SO₃). Then the process gas (10) is further cooled to about 100° C. in the sulfuric acid condenser (11), where the final hydration of SO₃ and condensation of H₂SO₄ takes place.

The sulfuric acid condenser (11) can either be configured with process gas (10) flowing in vertical tubes and cooling air (23) flowing on the shell side, or alternatively with process gas (10) on the shell side of horizontal tubes and cooling air (23) or sulfuric acid plant feed gas on the tube side. The sulfuric acid condenser can also be configured as a packed column where the process gas is contacted in counter current with circulating sulfuric acid.

The cleaned process gas (12) is optionally reheated by addition of hot air (25), and then the optionally heated gas (13) is emitted to the atmosphere through the stack (14).

Alternatively, the cleaned process gas (12) is sent to a tail gas treatment unit, provided that the composition of pollutants in the cleaned gas exceeds the local emission limits. Such tail gas treatment units are typically scrubbers for SO₂ removal and/or filters for sulfuric acid mist removal. The tail gas treatment unit can also be a second SO₂ converter and a second sulfuric acid condenser.

The sulfuric acid (47) condensed in the sulfuric acid condenser flows into the top of the concentrator column (55). On the top of the column is a liquid distributor, ensuring that the sulfuric acid being fed to the packed bed of the concentrator column is evenly distributed over the entire cross sectional area, providing the best possible contact between sulfuric acid and dried air. In the packed bed of the concentrator column, just downstream of the liquid distributor, the sulfuric acid is contacted in counter-current with hot dried air (45) produced in a dry air unit (40). The dried air is via line 41 compressed in the dry air blower (42) and via line 43 is directed to the dry air heater (44), typically heating the air to 200-300° C. before being sent to the concentrator column via line 45. By stripping off mainly water, but also some sulfuric acid, from the downward flowing sulfuric acid, the sulfuric acid concentration increases. The dried air containing the water and sulfuric acid vapors (46) flows into the bottom of the sulfuric acid condenser (11), where it is mixed with the process gas (10) coming from the process gas cooler (9).

In the sulfuric acid condenser, the process gas (10+46) is indirectly cooled with ambient air (23), which has passed through a particulate/dust filter (20) and via line 21 to the cooling air blower (22), where the air is compressed and directed to the sulfuric acid condenser via line 23.

The hot concentrated sulfuric acid leaving the bottom of the ISAC column (48) flows by gravity to the mixing point (75) of recirculated sulfuric acid (48) and carrier fluid (74).

The carrier fluid is typically air (70) that has been compressed in an air compressor (71) and via line 72 sent to an optional air heater (73) before led to the mixing point (75) through line 74. The sulfuric acid/air mixture (56) will pass through an optional sulfuric acid heater (53) and pass through a horizontal or slightly downward inclined pipe piece (54) to separate sulfuric acid and air before the separated fluids are directed to a position above the liquid distributor in the concentrator column (55). It can either be in the bottom of the sulfuric acid condenser (11) or in the concentrator column.

In the figure the separated sulfuric acid and air are admitted to the concentrator column via a single pipe, but doing the separation outside the concentrator and admitting the sulfuric acid and carrier fluid via separate pipes is also a possibility and will allow for optimal injection points for both streams.

The separation of sulfuric acid and carrier fluid can also be carried out in a vessel (vertical or horizontal) or a vertical pipe with an increased inner diameter compared to the riser pipe. The inner diameter of the separator pipe or vessel must be big enough to allow sufficient separation of sulfuric acid and carrier fluid, typically minimum 2-3 times the inner diameter of the riser pipe (56). The riser pipe will then typically extend at least about one pipe diameter into the vertical separator pipe. The sulfuric acid is discharged from the vertical separator pipe via a connecting pipe placed below the level of the end of the riser pipe. The carrier fluid is discharged from the top end of the separator pipe. The separated sulfuric acid and carrier fluid is then admitted via separate pipes to the optimal injection points.

The air from stream 54 is mixed with off gas from the sulfuric acid concentration column (46) and directed to the sulfuric acid condenser for cooling and condensation of sulfuric acid vapor.

As the lifting height of the air lift pump is limited, the pressure loss in sulfuric acid heater 53 is preferably as low as possible.

Therefore, a normal shell and tube or plate heat exchanger may not be applicable on the riser pipe section. A vertical pipe heat exchanger with e.g. microwave heating or electrical heating could be used on the riser section. An alternative solution is to increase the lifting height of the riser pipe, separate carrier gas and liquid and let the liquid flow downward by gravity to a heat exchanger before admitting the heated sulfuric acid to the concentrator column.

To ensure that there is a sufficient submerged height on line 48, an elevated reservoir or tank is preferably located at the inlet side of the air lift pump. It can either be integrated in the sulfuric acid concentrator column (55), be a separate tank or just the pipe piece, located between the outlet of the concentrator column and the inlet to the sulfuric acid and lifting medium mixing point (75).

The product stream (51) will typically flow through an overflow device in the above mentioned elevated reservoir, maintaining a constant height of the reservoir. The product stream could also be split from the sulfuric acid/air mixture pipe, provided that it is desired to elevate the sulfuric acid, e.g. for better gravitational flow. The product stream is cooled to 30-40° C. in a sulfuric acid cooling system (not shown) and sent for storage, transportation or direct use in another process.

As indicated above, the sulfuric acid circulation system can also be designed without the sulfuric acid heater (53), but then the temperature of the dried air (45) is preferably increased to 300-700° C. in order to supply sufficient energy to strip off water from the sulfuric acid. That can only be allowed by recycling sulfuric acid to the top of the concentrator column such that complete wetting of the packing is ensured and heat is efficiently transferred from the hot dried air to the down flowing sulfuric acid. Insufficient cooling of the hot dried air can damage the sulfuric acid condenser.

In such a layout with hot dried air, the sulfuric acid leaving the concentrator (48) could become too hot for the acid piping in the recirculation loop and to control that temperature, a stream of cold sulfuric acid (not shown) could be connected to the outlet piping. Such cold sulfuric acid stream could be the sulfuric acid product from the sulfuric acid product cooling system or any other colder sulfuric acid. The concentrator column can withstand higher sulfuric acid temperatures than the piping and thus a hot (and efficient) stripping could take place in the packed bed of the concentrator column, while the sulfuric acid piping is protected by injection of an amount of colder sulfuric acid into the piping system. Admitting too much cold sulfuric acid will require a higher heat supply via the hot stripping air.

Description of a WSA Plant Equipped with an External Sulfuric Acid Concentration Column and Sulfuric Acid Recirculation by Means of an Air Lift Pump

Another embodiment of the invention is shown in FIG. 4. In this embodiment, which for the most parts are similar to the WSA plant layout shown in FIG. 3, the concentrator column (55) is installed in an external vessel to the sulfuric acid condenser (11). The sulfuric acid from the sulfuric acid condenser (47) flows directly to mix with the recirculated sulfuric acid (48a) to be directed to the sulfuric acid/carrier fluid mixing point (75) via line 48b. This loosens the demands for elevation of the liquid outlet of the sulfuric acid condenser. In order to avoid liquid build-up in the sulfuric acid condenser, the elevation of the sulfuric acid condenser liquid outlet must be higher than the elevation of the liquid outlet of the sulfuric acid reservoir. In this embodiment, the sulfuric acid condenser height can be lower than in the embodiment as described in FIG. 3.

The carrier fluid is typically air (70), which has been compressed in the air compressor (71) and optionally fed to the air heater (73) via line 72 and directed to the sulfuric acid/air mixing point (75) via line 74.

The sulfuric acid/air mixture (56) is optionally heated in sulfuric acid heater (53) and air and sulfuric acid is separated in the horizontal or slightly downward inclined pipe 54 leading to a position above the liquid distributor (57) in the concentration column (55).

In the figure the separated sulfuric acid and air are admitted to the concentrator column via a single pipe, but doing the separation outside the concentrator and admitting the sulfuric acid and carrier fluid via separate pipes is also a possibility and will allow for optimal injection points for both streams.

The separation of sulfuric acid and carrier fluid can also be carried out in a vessel (vertical or horizontal) or a vertical pipe with an increased inner diameter compared to the riser pipe. The inner diameter of the separator pipe or vessel must be big enough to allow sufficient separation of sulfuric acid and carrier fluid, typically minimum 2-3 times the inner diameter of the riser pipe. The riser pipe will then typically extend at least about one pipe diameter into the vertical separator pipe. The sulfuric acid is discharged from the vertical separator pipe via a connecting pipe placed below the level of the end of the riser pipe.

The carrier fluid is discharged from the top end of the separator pipe. The separated sulfuric acid and carrier fluid is then admitted via separate pipes to the optimal injection points.

The recirculated sulfuric acid goes via the sulfuric acid distributor to the below packed bed, where the upward flowing hot dried air (45) strips off water (and some sulfuric acid), increasing the concentration of the down flowing sulfuric acid. The lifting air from 54 becomes mixed with the hot stripping medium (59) and passes through a demister (58) before mixed with hot air (32) and via line 46a mixed with the process gas from the SO₂ converter (10).

In order to prevent condensation of sulfuric acid in the process gas ducts (46a) and (10a), 300-700° C. hot air (32) is preferably added to the cleaned sulfuric acid concentrator off-gas air (46) before mixing with the process gas from the SO₂ converter (10). The combined process gas (10a) is then transferred to the sulfuric acid condenser (11). The source of hot air (32) is preferably a fraction of the hot cooling air (30) from the sulfuric acid condenser (11) which is further heated to a temperature of 300-700° C. in an additional air heater (31). Alternatively, the hot air (32) can be taken as a side stream from the hot dried air to the sulfuric acid concentrator (45).

Description of a Stand-Alone Version of the Improved Sulfuric Acid Concentrator

A stand-alone version of the sulfuric acid concentration unit using the present invention is shown in FIG. 5. The stand-alone version receives a cold sulfuric acid that requires heat exchange with the hot sulfuric acid product in order to have a high energy efficiency. As the air lift pump has limited discharge pressure/lifting height, a double air lift pump arrangement can be used.

Cold sulfuric acid feed (57) is first preheated in the sulfuric acid product cooler (58) by heat exchange with the hot concentrated sulfuric acid product stream (51). The sulfuric acid product cooler may be divided into a number of heat exchangers in series in different construction materials in order to reduce the investment costs. The heat exchanger 58 is characterized by the hot sulfuric acid product stream (51) flowing by gravity, the flow of cooled sulfuric acid product (59 and 62) can be controlled by a valve (61) which keeps the liquid level in the sulfuric acid reservoir in the sulfuric acid concentrator column or external reservoir constant.

The hot sulfuric acid product from the concentrator column (48) is directed to the first air lift pump mixing device (75), where a flow of carrier fluid (77), preferably air, is injected to form a two-phase flow moving upward in line 56. At a given height, the stream is split into a hot sulfuric acid product stream (51) flowing to the sulfuric acid product cooler (58), a hot sulfuric acid stream (79) flowing by gravity down to the second air lift pump (78) and a carrier fluid (81), preferably injected into a position above the sulfuric acid concentrator column (55) to be mixed with the stripping medium leaving the concentrator column (46). The split section (82) could be a reservoir in which the flow of hot sulfuric acid product (51) is controlled by a simple overflow pipe and hence the flow control valve (61) could be omitted.

The amount of sulfuric acid recycled via line (79) depends on the initial concentration of the sulfuric acid feed (57) and the desired concentration of the sulfuric acid product (62). The higher the difference in concentration, the higher the recycle flow will be.

In the second air lift pump (78), the recirculated hot sulfuric acid stream (79) is mixed with the heated sulfuric acid feed (60) coming from the sulfuric acid product cooler (58). A flow of carrier fluid (77) is injected into the mixer (78), such that the two-phase fluid (80) moves upwards to the optional sulfuric acid heater (53), heating the sulfuric acid to 200-270° C. and via line 54 is admitted to the sulfuric acid concentrator (55) in a position above the liquid distributor in the packed bed. The line is either horizontal or slightly downward inclined to ensure good separation of the sulfuric acid and carrier fluid. In the figure the separated sulfuric acid and air are admitted to the concentrator column via a single pipe, but doing the separation outside the concentrator and admitting the sulfuric acid and carrier fluid via separate pipes is also a possibility and will allow for optimal injection points for both streams.

The separation of sulfuric acid and carrier fluid can also be carried out in a vessel (vertical or horizontal) or a vertical pipe with an increase inner diameter compared to the riser pipe. The inner diameter of the separator pipe or vessel must be big enough to allow sufficient separation of sulfuric acid and carrier fluid, typically minimum 2-3 times the inner diameter of the riser pipe. The riser pipe will then typically extend at least about one pipe diameter into the vertical separator pipe. The sulfuric acid is discharged from the vertical separator pipe via a connecting pipe placed below the level of the end of the riser pipe. The carrier fluid is discharged from the top end of the separator pipe. The separated sulfuric acid and carrier fluid is then admitted via separate pipes to the optimal injection points.

The recirculated sulfuric acid from line 54 combines with the sulfuric acid from the sulfuric acid condenser (47) and flow to the sulfuric acid distributor to be evenly distributed across the packed bed. Water and a little sulfuric acid is stripped from the sulfuric acid by the upward flowing hot dried air (45), which has been dried in a drying unit (40), compressed in a dry air blower (42), first heated in the sulfuric acid condenser (11), further heated in dry air heater (44) and directed to the sulfuric acid concentrator via pipes 41, 43, 24 and 45. The dried air is heated to 180-240° C. on the shell side of the sulfuric acid condenser and leaves the sulfuric acid condenser at the bottom outlet via line (24). This partially heated dried air is further heated to about 300-700° C. in the air heater (44) before being sent through the line (45) to the air inlet of the concentrator column (55). The final heating of the air can be carried out by electrical heating or indirect heat exchange with e.g. saturated or superheated steam, process gas, molten heat transfer salt or heat transfer oil or with a combination of the above-mentioned methods.

The water and sulfuric acid containing stripping medium (46) combines with the carrier fluids 54 and 81 and passes through the sulfuric acid condenser in which the air is cooled, sulfuric acid condensed and returned to the concentrator column and humid air leaves the condenser via line 12. In the sulfuric acid condenser, the gas (45+81+gas part of 54) is cooled to typically 70-120° C. and the sulfuric acid vapor is condensed as 90-98 wt % H₂SO₄.

Preferably the condenser off gas (12) is passed through a mist eliminator (16) to remove small amounts of sulfuric acid mist before the off gas is released to the atmosphere (17). The mist eliminator can be of any type: low velocity candle filters or wet electrostatic precipitators are the most used technologies.

The carrier fluid is typically air, either ambient or dried air (70) which is compressed in compressor/blower 71 and optionally heated in air heater 73 via line 72 and 74. The air is split into a fraction going to the first air lift pump (76) and a fraction going to second air lift pump (77).

In an alternative embodiment, the sulfuric acid product (51) is withdrawn from an overflow pipe in the sulfuric acid reservoir, either integrated in the concentrator column or in an external vessel. By ensuring that the elevation between overflow pipe and sulfuric acid product cooler (58) is sufficiently high, the hot sulfuric acid product can flow by gravity and thus exchange heat with the cold sulfuric acid feed (57). In such a layout, the first air lift pump (75) can be omitted and the recycled hot sulfuric acid (48) can be directed to the second air lift pump (78) to be mixed with the heated sulfuric acid feed (60) and the carrier fluid (76).

In a special embodiment, the recycle sulfuric acid heater (53) is foreseen to be of the type plate-and-frame, block, shell-and-tube, double tube or similar. The heating medium for the recycle sulfuric acid heater is foreseen to be heat transfer oil but it can also be other heat transfer media like superheated steam, condensing high pressure steam or molten heat transfer salt. Alternatively, the heating can be done directly by electrical means, either by thermal conduction from a resistor or electrical energy converted into microwaves, which are absorbed into the sulfuric acid in a tube or flow cell.

A recycle heater using a double-tube arrangement with heat transfer oil as the heating medium is described in DE 10 2007 059 802 B3.

In a special embodiment, the recycle sulfuric acid heater is omitted, and in order to supply sufficient heat into the system, the hot air temperature must be increased to 350-700° C.

The invention is described further in the examples which follow.

### EXAMPLE 1

To evaluate and optimize the air lift pump for performance in the sulfuric acid concentrator layout, experiments have been carried out with water as the liquid phase and plant air as the carrier fluid. The temperature of both fluids were room temperature, i.e. 20-25° C.

The experimental setup consisted of an elevated reservoir, a downcomer pipe extending below the reservoir, a vertical riser pipe higher than the downcomer pipe (, a horizontal pipe for separation of air and water and a pipe for returning the water back to the reservoir. The air injection device was located in the bottom of the riser pipe, as close as possible to the bottom while avoiding back flow of air to the pipe connected to the reservoir.

The plant air flow was controlled by a valve and measured with a variable area meter.

The inner pipe diameter for both downcomer and riser was 46 mm. Different designs of the air injection device were tested. Single vertical tubes with variable diameters were tested, but also hole plates with several smaller holes were tested.

The water level in the reservoir could be varied to test the effect of submerged height compared to the total height of the lifting section (=submerged height+lifting height). The total height of the lifting section was 3.05 meters and the submerged height was either 1.45 or 1.15 meter. The so-called submergence ratio was then 1.45/3.05=0.48 or 1.15/3.05=0.38.

The experimental results are shown in Table 1. Experiments #1 to #7 document that the liquid flow is easily controlled by the flow of carrier fluid, i.e. higher carrier fluid flow results in a higher liquid flow. However, there is an upper limit to the liquid flow as the effect of increasing the carrier fluid flow decreases with carrier fluid flow and ultimately the liquid flow could start decreasing.

If higher liquid flow capacities are needed, the pipe diameter can be increased, the submergence ratio can be increased or two or more parallel air lift pumps with a lower capacity can be used.

Experiments #5 and #8 to #12 show that the air injecting device design had a measurable effect on the liquid flow, however the span between the most and the least effective design was around 10%.

Experiments #5, #9, #13 and #14 show the effect of the submergence ratio, documenting a 50% liquid flow increase by increasing the submergence ratio from 0.38 to 0.48, either by increasing the height of the reservoir and/or decreasing the lifting height.

TABLE 1

| | | | | Submergence |
|---|---|---|---|---|
| Experiment | Air nozzle | Air flow | Liquid flow | ratio |
| # | type | [m³/h] | [l/h] | [—] |
| 1 | 1x Ø10 mm | 7 | 800 | 0.38 |
| 2 | 1x Ø10 mm | 11 | 1250 | 0.38 |
| 3 | 1x Ø10 mm | 16 | 1550 | 0.38 |
| 4 | 1x Ø10 mm | 21 | 1750 | 0.38 |
| 5 | 1x Ø10 mm | 25 | 1920 | 0.38 |
| 6 | 1x Ø10 mm | 33 | 2200 | 0.38 |
| 7 | 1x Ø10 mm | 40 | 2400 | 0.38 |
| 8 | 1x Ø8 mm | 25 | 1835 | 0.38 |
| 9 | 1x Ø12.5 mm | 25 | 2000 | 0.38 |
| 10 | 1x Ø27 mm | 25 | 1935 | 0.38 |
| 11 | 5x Ø3.5 mm | 25 | 1750 | 0.38 |
| 12 | 9x Ø3.5 mm | 25 | 1920 | 0.38 |
| 13 | 1x Ø10 mm | 25 | 2950 | 0.48 |
| 14 | 1x Ø12.5 mm | 25 | 3050 | 0.48 |

### EXAMPLE 2

This example, illustrates the design of an industrial scale WSA plant which is fitted with an externally located sulfuric acid concentrator in a configuration as shown in FIG. 4.

The WSA plant is treating an off gas from a power plant, producing around 4 t/h concentrated sulfuric acid with a H₂SO₄ concentration of 94.5 wt %. The desired sulfuric acid product concentration is 98.0 wt % H₂SO₄.

The layout shown in FIG. 3 could also have been used, but due to the size of the sulfuric acid condenser, more than a single sulfuric acid concentrator would have been necessary as the condenser would be equipped with more than a single sulfuric acid outlet pipe.

Apart from the concentrated sulfuric acid from the sulfuric acid condensers, a small stream of 50 kg/h 70 wt % H₂SO₄ is added to the sulfuric acid line (47).

The sulfuric acid concentrator withdraws carrier fluid for the air lift pump (72) from the pressurized air system of the power plant. The carrier fluid is preheated in the carrier fluid heater (73) before being mixed with the recycled sulfuric acid (48b). The flow of carrier fluid corresponds to 12-15 Nm³ carrier fluid per ton sulfuric acid.

The bottom section of the concentration column acts as a reservoir for the sulfuric acid, and the submerged height is 2.8 meters and the lifting height is 3.6 meters, i.e. the submergence ratio as defined in example 1 is 2.8/(2.8+3.6)=0.44.

The liquid level in the reservoir is kept constant by an overflow pipe, leading the hot sulfuric acid product (51) to a sulfuric acid cooling circuit for cooling to 30-40° C. and afterwards pumped to a storage tank.

The sulfuric acid recycle flow (48b) is 11 tons/h, i.e. a recycle ratio of 3 compared to the sulfuric acid product flow of 3.7 tons/h. The sulfuric acid piping is ID 75 mm PTFE-lined steel pipes.

The sulfuric acid heater (53) has been omitted in this design, and hence the energy for the sulfuric acid heating and water evaporation is supplied via the stripping medium (45).

The stripping medium is ambient air, dried to a 15° C. dew point temperature by cooling with a water/glycol solution produced in a chiller unit (40), compressed in dried air blower (42) and heated to 540° C. in the dried air heater (44), which in this case is an electric heater.

The off gas from the packed column and demister (46) is mixed with an amount of hot air taken from the sulfuric acid cooling air outlet stream (24) and further heated in hot air heater (31), which in this case is an electrical heater. Other options for heating could be superheated steam, molten salt or another hot process gas.

The combined sulfuric acid concentrator off gas (46a) is mixed with the process gas from the SO₂ converter (10) and passed to the sulfuric acid condenser (11).

The combined sulfuric acid concentrator off gas (46a) corresponds to less than 2% of the process gas (10), and thus the effect on size of the sulfuric acid condenser (11) is very small.

The combined sulfuric acid concentrator off gas (46a) comprises the stripping medium (45), the hot air (32), the air lift pump carrier fluid (62) and the amount of evaporated water (and sulfuric acid). The contribution from the air lift pump carrier fluid is around 3% of the total off gas and around 0.05% of the process gas from the SO₂ converter (10), i.e. the air consumption for the air lift pump is insignificant to affect the design or operation of both WSA plant and sulfuric acid concentrator.

### EXAMPLE 3

In this example, a WSA plant is equipped with an external sulfuric acid concentrator as shown in FIG. 4.

The process gas is from a combustion process. As the process gas has a very high water concentration, the sulfuric acid concentration from the sulfuric acid condenser is only 89.3 wt % H₂SO₄ and the flow is 2215 kg/h. The desired sulfuric acid concentration is 93 wt % H₂SO₄, which is very suitable for e.g. the manufacture of phosphate fertilizer. The resulting sulfuric acid product flow is 2125 kg/h.

As the difference in water vapor and sulfuric acid is much higher at 89 wt % than at 94 wt % it is much easier to concentrate from 89 wt % to 93 wt % H₂SO₄ than from 94 wt % to 98 wt % H₂SO₄, the sulfuric acid concentrator in this example can be designed with less stringent demands for water content in the stripping medium and energy input to the stripping section.

The sulfuric acid concentrator is to a large extent configured as in Example 2, however the carrier fluid heater (73) has been omitted, as the demand for concentrating the sulfuric acid is modest. The carrier fluid flow corresponds to 12-15 Nm³ carrier fluid per ton sulfuric acid.

The submergence ratio is 0.44 as in Example 2. The sulfuric acid recirculation ratio is 2.4 compared to the sulfuric acid product flow. The sulfuric acid piping is ID 63 mm PTFE-lined steel pipes.

In this case the stripping medium (45) is cooling air from the sulfuric acid condenser (24), which has been further compressed in a blower (42) and further heated to 330° C. in the air heater (44) before being admitted to the sulfuric acid concentrator column (55). The stripper off gas (46) is mixed with hot air (32), which is also hot air from the sulfuric acid condenser (24), compressed in a blower and further heated in the hot air heater (31), which in this layout is an electric heater.

The total sulfuric acid concentrator column off gas (46a) is then mixed into the process gas flow from the SO₂ converter (10); the off gas corresponds to less than 1% of the process gas flow from the SO₂ converter.

The carrier fluid flow (72) corresponds to less than 3% of the concentrator column off gas and around 0.02% of the total process gas from the SO₂ converter, i.e. the carrier fluid flow has no practical impact on the size and operation of neither sulfuric acid concentrator nor WSA plant.

Compared to Example 2, the consumption numbers (flow, power etc.) for the sulfuric acid concentrator are much lower, which is a consequence of lower demands for the concentration of the final product and not the demand for a degree of concentration, as both sulfuric acid condenser sulfuric acids have been increased by around 4 wt % H₂SO₄.

1. A sulfuric acid recirculation loop comprising:
an optional sulfuric acid condenser column,
a concentrator column,
an air lift pump having a liquid inlet fed with hot concentrated sulfuric acid from the outlet of a sulfuric acid reservoir downstream the concentrator column, a gas inlet fed with a carrier fluid having a lower density than the hot concentrated sulfuric acid, and an outlet,
wherein the sulfuric acid reservoir is located below the concentrator column and above the carrier fluid inlet of the air lift pump,
a downcomer pipe leading down from the sulfuric acid reservoir to the liquid inlet of the air lift pump, and
a riser pipe leading up from the carrier fluid inlet in the air lift pump to an inlet pipe for the concentrator column, said inlet pipe having an inlet and an outlet and an increased diameter compared to the riser pipe, and said inlet pipe being configured for allowing a liquid flow from the inlet to the outlet and configured for at least partially separating recirculated sulfuric acid and carrier fluid, and directing both fluids to the inlet of the concentrator column.

2. A sulfuric acid recirculation loop according to claim 1, in which sulfuric acid product is withdrawn through an overflow pipe in the sulfuric acid reservoir.

3. A sulfuric acid recirculation loop according to claim 1, further comprising a sulfuric acid heater positioned between the outlet of the air lift pump and the inlet to the sulfuric acid concentrator column, and where the sulfuric acid and optionally the carrier fluid from the outlet of the air lift pump is heated to a temperature of 200-270° C.

4. A sulfuric acid recirculation loop according to claim 1, in which the carrier fluid is air that is optionally heated in carrier fluid heater positioned upstream the air lift pump.

5. A sulfuric acid recirculation loop according to claim 1, comprising two or more air lift pumps arranged in parallel.

6. A sulfuric acid recirculation loop according to claim 1, in which the inlet pipe is split into a dedicated pipe for sulfuric acid and a dedicated pipe for carrier fluid, the two pipes directing their fluids to positions above the inlet of the concentrator column and/or at the bottom of sulfuric acid condenser.

7. A sulfuric acid recirculation loop according to claim 1, in which the separation of sulfuric acid and carrier fluid, coming from the riser pipe, is carried out in a separator vessel or a separator pipe with an inner diameter larger than the inner diameter of the riser pipe, and two connecting outlets connecting a dedicated pipe for sulfuric acid and a dedicated pipe for carrier fluid, the two pipes directing their fluids to positions above the inlet of the concentrator column and/or at the bottom of sulfuric acid condenser.

8. A sulfuric acid recirculation loop according to claim 1, in which a stream of sulfuric acid, colder than the recirculated sulfuric acid, is mixed with the recirculated sulfuric acid in a position upstream the inlet to the air lift pump.

9. A stand-alone sulfuric acid concentrator system comprising
a concentrator column having an inlet and an outlet,
an optional sulfuric acid condenser column,
a first air lift pump having a liquid inlet fed with hot concentrated sulfuric acid from the outlet of a concentrator column a gas inlet fed with a first carrier fluid, having a lower density than the hot concentrated sulfuric acid, and an outlet,
a separating unit, in which the stream from first air lift pump is split into a hot sulfuric acid product stream directed to the sulfuric acid product cooler, a sulfuric acid stream for recirculation and said first carrier fluid being directed to the inlet of the concentrator column or to the bottom of the sulfuric acid condenser,
a sulfuric acid product cooler for pre-heating a cold sulfuric acid feed stream by heat exchange with a hot concentrated sulfuric acid product stream,
a second air lift pump, having a liquid inlet fed with the sulfuric acid stream for recirculation and the preheated sulfuric acid feed and a gas inlet fed with a second carrier fluid, having a lower density than the sulfuric acid stream for recirculation, and an outlet,
an inlet pipe, said inlet pipe having an inlet and an outlet and an increased diameter compared to the riser pipe, said inlet pipe being configured for allowing a liquid flow from the inlet to the outlet and configured for at least partially separating sulfuric acid and second carrier fluid, and directing both fluids to the inlet of the concentrator column or to the bottom of the sulfuric acid condenser,
a sulfuric acid reservoir located upstream of and above the first air lift pump, either integrated in the concentrator column or as a separate tank or vessel.

10. A stand-alone sulfuric acid concentrator according to claim 9, further comprising a sulfuric acid heater, positioned such that the stream from the second air lift pump is heated to 200-270° C. before being fed to the inlet of the concentrator column or the bottom of the sulfuric acid condenser.

11. A stand-alone sulfuric acid concentrator according to claim 9, in which the carrier fluid is air and is optionally heated in carrier fluid heater upstream the first and second air lift pump.

12. A stand-alone sulfuric acid concentrator according to claim 9, comprising two or more air lift pumps arranged in parallel.

13. A sulfuric acid recirculation loop according to claim 9, in which the inlet pipe comprises a dedicated pipe for sulfuric acid and a dedicated pipe for carrier fluid, the two pipes directing their fluids to positions above the inlet of the concentrator column and/or at the bottom of sulfuric acid condenser.

14. A sulfuric acid recirculation loop according to claim 9, in which the separation of sulfuric acid and carrier fluid coming from the riser pipe is carried out in a separator vessel or a separator pipe with an inner diameter larger than the inner diameter of the riser pipe, and two connecting outlets connecting a dedicated pipe for sulfuric acid and a dedicated pipe for carrier fluid, the two pipes directing their fluids to positions above the inlet of the concentrator column and/or at the bottom of the sulfuric acid condenser.

15. A sulfuric acid recirculation loop according to claim 9, in which a stream of sulfuric acid, colder than the recirculated sulfuric acid, is mixed with cooled recirculated sulfuric acid in a position upstream the inlet to the air lift pump.
